(19) United States
(12) Patent Application Publication
(10) Pub. No.: US 2007/0174787 A1
(43) Pub. Date: Jul. 26, 2007

(54) Device and method for providing information about relationships between respective sharers based on shared information

(75) Inventor: Young-ho Rhee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/635,036

(22) Filed: Dec. 7, 2006

(30) Foreign Application Priority Data
Jan. 25, 2006 (KR) 10-2006-0007716

(51) Int. Cl. G06F 3/048

(52) U.S. Cl. 715/810; 715/759

(57) ABSTRACT

A device and method for providing information about the relationships between a user of a device and sharers sharing data with the user is provided. The device includes a search unit, a storage unit, a User Interface (UI) generation unit, and a display unit. The search unit searches for information about the lower menu item icons of a specific menu item icon, and sharer icons representing sharers who share each of the lower menu item icons, when a user selects the specific menu item icon. The storage unit stores information about the menu item icon, the lower menu item icons, and the sharer icons for respective layer regions. The UI generation unit generates the menu item icons, the lower menu item icons, and the sharer icons. The display unit displays the generated menu item icons, lower menu item icon, and sharer icons.

### CROSS-REFERENCE TO RELATED APPLICATION

This application claims priority from Korean Patent Application No. 10-2006-0007716 filed on Jan. 25, 2006 in the Korean Intellectual Property Office, the disclosure of which is incorporated herein by reference in its entirety.

### BACKGROUND OF THE INVENTION

1. Field of the Invention

Methods and apparatuses consistent with the present invention relate to providing information about the relationships between respective sharers based on shared information and, more particularly, to providing information about the relationships between a user who possesses a mobile device and sharers who share specific data with the user, through a user interface.

2. Description of the Related Art

In modem mobile communication terminals such as mobile phones, a voice communication service provides a short message transmission service, and sharers are also able to download and use desired files, such as games, pictures, ringtones, phone books and electronic (e)-calling cards, via the Internet.

The user previously stores necessary information about various telephone numbers and contact addresses in his or her mobile communication terminal using PCSync, which enables the implementation of a synchronization function using Synchronization Markup Language (SyncML). Thereafter, the user can perform voice communication or receive necessary information after connecting to another party or a server by using the stored information at a specific period or inputting specific information via a keypad.

Korean Unexamined Pat. Appl. No. 2005-0021925, entitled “Information Processing Apparatus and Method, Information Processing Program, and Storage Medium Storing Information Processing Program Therein,” discloses a new scrollbar that indicates the currently displayed portion of an entire menu on a display when it is not possible to display the entire menu on a single display, and also the location of a current cursor in the currently displayed menu on the display. However, the related art technology, which provides a cursor display method that makes a user intuitively aware of a scroll direction and a scroll speed, does not provide an application indicating information about shared files.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a device and method for providing information about the relationships between a user of the device and sharers sharing data with the user, wherein information about the relationships between a user of a mobile device and sharers sharing specific data with the user, is provided through a user interface.

According to an aspect of the present invention, there is provided a device and method for providing information about the relationships between a user of the device and sharers sharing data with the user, and for generating and displaying a user interface (UI) (for example, icons) based on the amount of data and the number of sharers that are stored in a mobile device, thus allowing the user to intuitively receive information through the UI.

According to another aspect of the present invention, there is provided a device for providing information about relationships between a user of the device and sharers sharing data with the user, the device including a display panel displaying the lower menu item icons of a specific menu item icon, and sharer icons indicating the relationships between sharers sharing each of the lower menu item icons, when a user selects the specific menu item icon from among displayed menu item icons; and a manipulation unit performing manipulation and selection of the displayed menu item icons, lower menu item icons, and sharer icons.

According to another aspect of the present invention, there is provided a device for providing relationships between a user of the device and sharers sharing data with the user, the device including a search unit searching for information about the lower menu item icons of a specific menu item icon, and sharer icons representing sharers who share each of the lower menu item icons, when a user selects the menu item icon; a storage unit storing information about the menu item icon information, the lower menu item icons, and the sharer icons for respective layer regions; a UI generation unit generating the menu item icons, the lower menu item icons, and the sharer icons; and a display unit displaying the generated menu item icons, lower menu item icon, and sharer icons.

According to another aspect of the present invention, there is provided a method of providing information about the relationships between a user of the device and sharers sharing data with the user, the method including searching for information about the lower menu item icons of a specific menu item icon and displaying the lower menu item icons, when a user selects a specific menu item icon from among displayed menu icons; searching for information about the specific lower menu item icon when the user selects the lower menu item icon from among the displayed lower menu item icons; and searching for information about sharer icons sharing the selected lower menu item icon, and displaying the sharer icons.

### BRIEF DESCRIPTION OF THE DRAWINGS

The above and other aspects of the present invention will be more clearly understood from the following detailed description of the exemplary embodiments taken in conjunction with the accompanying drawings, in which:

FIG. 1 is a diagram showing an example of displaying of sharer icons on the display panel of a device for providing information about the relationships between respective sharers based on shared information, according to an exemplary embodiment of the present invention;

FIG. 2 is a block diagram showing the internal construction of the device for providing information about the relationships between respective sharers based on shared information, according to an exemplary embodiment of the present invention;

FIG. 3 is a diagram showing a table containing unique information for each layer region, which is stored in the storage unit of the device for providing information about the relationships between respective sharers based on shared information, according to an exemplary embodiment of the present invention;

FIG. 4 is a diagram showing a table giving an example of generation of icons using the UI generation unit of the device for providing information about the relationships between respective sharers based on shared information, according to an exemplary embodiment of the present invention;

FIG. 5 is a flowchart illustrating a method of providing information about the relationships between respective sharers based on shared information according to an exemplary embodiment of the present invention; and

FIGS. 6A to 6F are diagrams showing a process of providing information about the relationships between respective sharers based on shared information according to an exemplary embodiment of the present invention.

### DESCRIPTION OF THE EXEMPLARY EMBODIMENTS OF THE INVENTION

The advantages and characteristics of the present invention, and the method of achieving them, will be apparent with reference to exemplary embodiments described in detail later in conjunction with the accompanying drawings. However, the present invention is not limited to the exemplary embodiments disclosed below, but may be implemented in various ways. Furthermore, the exemplary embodiments are provided to complete the disclosure of the present invention, and to fully notify those skilled in the art of the scope of the present invention. The exemplary embodiments of the present invention are defined only by the appended claims. The same reference numerals are used throughout the different drawings to designate the same or similar components.

Exemplary embodiments of the present invention are described in detail with reference to the accompanying drawings below.

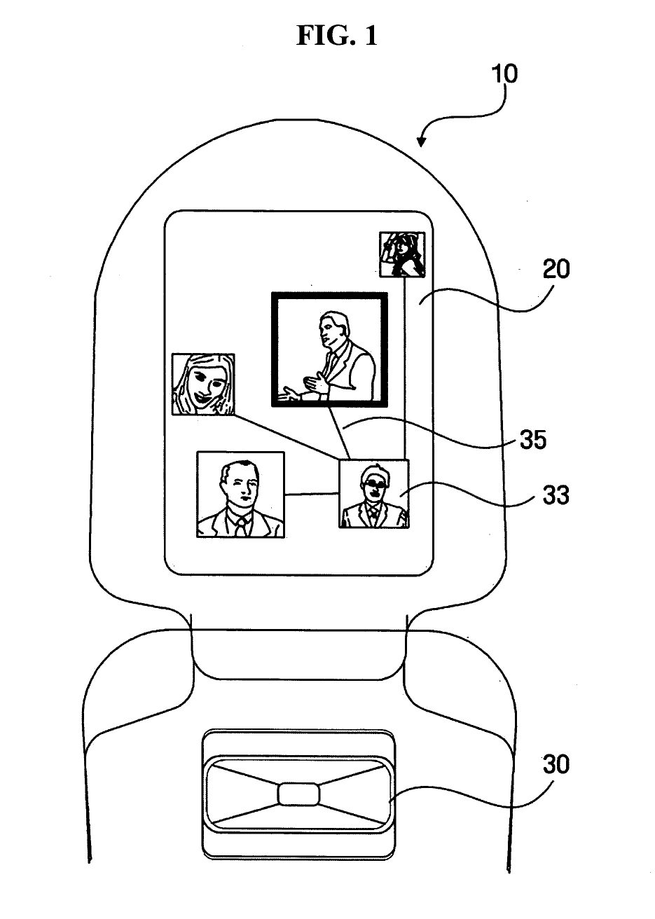

FIG. 1 is a diagram showing an example of displaying of sharer icons on the display panel of a device for providing information about the relationships between respective sharers based on shared information, according to an exemplary embodiment of the present invention.

As shown in FIG. 1, the device 10 for providing information about the relationships between respective sharers based on shared information includes a display panel 20, and a manipulation unit 30, through which a user performs manipulation and selection of icons displayed on the display panel 20. The description of the device 10 for providing information about the relationships between respective sharers based on shared information according to the exemplary embodiments of the present invention is given by way of example below. In this case, the mobile device 10 refers to a mobile phone, a Personal Digital Assistant (PDA), a Portable Multimedia Player (PMP), or the like.

When a user selects a menu item icon, the display panel 20 displays the lower menu icons of the menu item icon, and sharer icons, which indicate the relationships with sharers who share the lower menu item icon.

The manipulation unit 30 is used to perform manipulation and selection of the menu item icons, the lower menu item icons and the sharer icons, which are displayed on the display panel 20, and may be understood to include a four-directional button and functional buttons.

For example, the sharer icons 33 are displayed on the display panel 20 of the mobile device 10. In this exemplary embodiment, the sharer icons 33 refer to icons that represents sharers who share specific data (or information) with the user of the mobile device 10. The sharer icons 33 may be generated in a thumbnail manner, and may indicate only predetermined information about the respective sharers.

Furthermore, the size and color of each of the sharer icons 33 are determined based on the relationships between the user of the mobile device 10 and the sharers. In this case, the relationships between the user of the mobile device 10 and the sharers may be determined by the amount of telephone communication, the number of exchanged messages, and the number of specific files that are shared between the sharers and the user.

That is, the relationship between the user and a specific sharer is determined based on the proportion of an increase in the amount of telephone communication, the number of exchanged messages, and the number of files that are shared between the user and the specific sharer, and the size of each of the sharer icons increase in proportion to the magnitude of the relationship between the user and the specific sharer.

For example, when a specific picture file stored in the mobile device 10 is shared by sharers A, B, and C, sharer icons (that is, icons that represent the sharers A, B, and C) 33 for the respective sharers are displayed on the display panel 20. In this case, the size and color of each of the displayed sharer icons 33 are determined based on the relationships between the user of the mobile device 10 and the sharers.

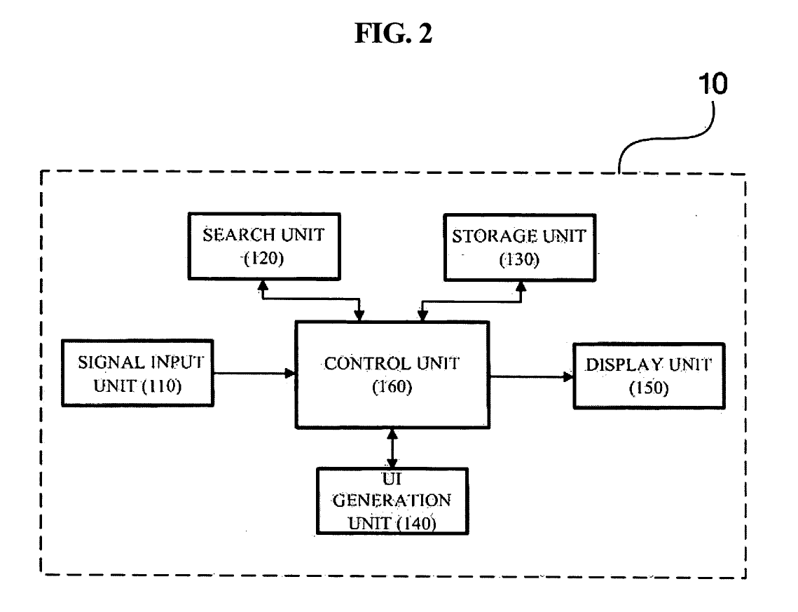

FIG. 2 is a block diagram showing the internal construction of the device for providing information about the relationships between respective sharers based on shared information, according to an exemplary embodiment of the present invention.

As shown in FIG. 2, the mobile device 10 includes a signal input unit 110, a search unit 120, a storage unit 130, a UI generation unit 140, a display unit 150, and a control unit 160.

The term ‘unit,’ as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and may be configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or may be further separated into additional components and modules. Furthermore, the components and modules may be implemented to operate on one or more Central Processing Units (CPUs) residing in a device or a security multimedia card.

The signal input unit 110 receives a button signal generated according to the user's selection. That is, when a specific input button is selected by the user, the button signal generated by the selection is received.

The search unit 120 searches for information about a menu item icon, which is selected by the user, in response to the signal received through the signal input unit 110. Furthermore, the search unit 120 also searches for information about the lower menu item icons of a selected menu item icon, but also for information about sharers who share the lower menu item icon.

Furthermore, the search unit 120 determines the relationships between the user of the mobile device 10 and the sharers based on information pertaining to the sharers. In this case, the relationships between the user of the mobile device 10 and the sharers may be determined by the amount of telephone communication, the number of exchanged messages, or the number of files that are shared between the user and the sharers. In this case, information about the determined relationship may be used at the time of setting the size and color of each of the sharer icons that represent the sharers.

For example, when the user selects the lower menu item icon ‘A’ of a picture menu item icon, the search unit 120 searches not only for information about the selected lower menu item icon ‘A’ of the picture menu item icon, but also for information about sharers sharing the selected lower menu item icon ‘A’ according to the results of the search.

Thereafter, the sharer icons, which are generated based on the information pertaining to the sharers, and the lower menu item icon are connected to each other through connection lines 35, and the result of the connection is displayed.

The storage unit 130 stores metadata and image files, regarding the user, the menu item icons, the lower menu item icons and the sharer icons, for respective layer regions.

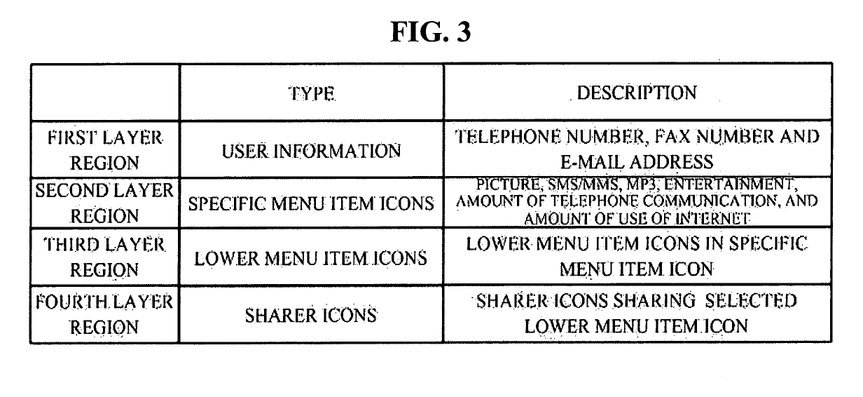

For example, various pieces of information about the user (for example, the user's telephone number, fax number and e-mail address) are stored in a first layer region, and the menu item icons stored in the mobile device 10 are stored in a second layer region. Furthermore, the lower menu item icons of each of menu item icons stored in the second layer region are stored in a third layer region, and information about the sharer icons, sharing each of the lower menu item icons stored in the third layer region, is stored in a fourth layer region. A table in which information is stored for each layer region is described in detail with reference to FIG. 3 below.

The UI generation unit 140 generates icons by taking the size and color of each of the menu item icons, the lower menu item icons, and the sharer icons into account based on the number of lower menu item icons and the number of sharer icons. Furthermore, the UI generation unit 140 determines the thickness of the connection lines 35 based on the number of lower menu item icons and the number of sharer icons.

That is, the size and color of each of the menu item icons are determined according to the number of lower menu item icons included in a specific menu item icon, and the thickness of the link lines 35 that connect each menu item icon and the lower menu item icons thereof is also determined thereby.

Furthermore, the size and color of each of the lower menu item icons are determined according to the number of sharers (that is, sharer icons) sharing a specific lower menu item icon, and the size and color of each of the sharer icons are determined according to the relationships between the user of the mobile device 10 and the sharers (that is, the amount of telephone communication, the number of exchanged messages, and the number of files that are shared between the sharers and between the user and the sharers).

The UI generation unit 140 may generate a UI to which any of icon size, icon color, and connection line thickness is applied, or to which all of them are applied.

Accordingly, the user may be made aware of the amount of data in each of the menu item icons and of the number of sharers who are sharing each of the lower menu item icons, only by the icon size and color and the connection line thickness. An example in which the UI generation unit 140 generates icons will be described in detail below.

In an example, an assumption is made that a picture menu item icon and an MPEG Layer-3 (MP3) menu item icon are displayed on the display panel 20 of the mobile device 10, forty lower menu item icons are included in the picture menu item icon, and twenty lower menu item icons are included in the MP3 menu item icon.

Accordingly, the picture menu item icon is displayed on the display panel 20 of the mobile device to be larger than the MP3 menu item icon.

Furthermore, when a lower menu item icon included in a specific menu item icon is selected and activated, the UI generation unit 140 displays the upper menu item icon of the activated lower menu item icon (that is, the menu item icon) in a predetermined region of the display panel 20. Accordingly, the user can be made immediately aware of the menu item icon, which includes a currently activated lower menu item icon.

The display unit 150 displays the icons (menu item icons, lower menu item icons, and sharer icons), which are generated by the UI generation unit 140, and detailed information about the sharers.

The control unit 160 controls the respective operations of the functional blocks 110 to 150 constituting the mobile device 10.

FIG. 3 is a diagram showing a table containing unique information for each layer region, which is stored in the storage unit of the device for providing information about the relationships between respective sharers based on shared information, according to an exemplary embodiment of the present invention.

As shown in FIG. 3, information about the user of the mobile device 10 is stored in the first layer region. In this case, the user information refers to various pieces of information representing the user, like his or her telephone number, fax number, and e-mail address.

Furthermore, information about menu item icons, which represent files generated manually by the user of the mobile device 10, received PC documents, and transmitted and received messages, is stored in the second layer region. In this case, each of the menu item icons includes information about a predetermined menu item, and an image file regarding the predetermined menu item.

For example, the menu item icons refer to a picture menu item icon, an Short Messaging Service (SMS)/Multimedia Messaging Service (MMS) menu item icon, an MP3 menu item icon, an entertainment menu item icon, a menu item icon for information about the amount of telephone communication, a menu item icon for information about the amount of use of the Internet, and the like.

That is, when the user selects a specific menu item icon (for example, a picture menu item icon), the search unit 120 searches for menu item icon information stored in the second layer region, and allows the user to be made aware of the fact that the selected menu item icon is the picture menu item icon.

Furthermore, information about the lower menu item icons of each of the menu item icons stored in the second layer region is stored in the third layer region.

For example, lower menu item icons (for example, ‘Yesterday’, ‘Let it be’, ‘Goodbye’, ‘Honesty’, and ‘Last Christmas’ icons), which are related to the MP3 menu item icon stored in the second layer region, are stored in the third layer region.

Furthermore, information about sharers (that is, sharer icons) sharing each of the lower menu item icons stored in the third layer region is stored in the fourth layer region. That is, the sharer icons stored in the fourth layer includes information about certain sharers who have a relationship with the user of the mobile device. In this case, the sharer icons include detailed information about sharers who share each of the lower menu item icons. The detailed information about the sharers may be understood to include telephone numbers, the amount of telephone communication, the number of text transmissions, and the number of files that are shared between the sharers and between the sharers and the user.

For example, sharer icons (for example, for Hong Gil-Dong, Lee Soon-Sin, and Yoo Kwan-Soon) which share a lower menu item icon (for example, a ‘Yesterday’ file) stored in the third layer region are stored in the fourth layer region.

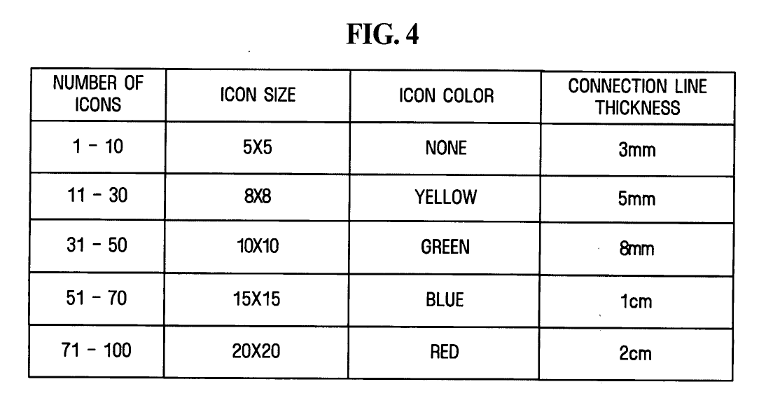

FIG. 4 is a diagram showing a table giving an example of the generation of icons using the UI generation unit of the device for providing information about the relationships between respective sharers based on shared information, according to an exemplary embodiment of the present invention.

When generating predetermined icons, the UI generation unit 140, as shown in FIG. 4, generates the icons (menu item icons, lower menu item icons, and sharer icons) based on a table that defines varying icon size, icon color and connection line thickness according to the number of icons.

First, the UI generation unit 140 checks the number of lower menu item icons, which are included in a specific menu item icon, to generate the menu item icons. In this case, the UI generation unit 140 searches the third layer region of the storage unit 130 for information about lower menu item icons included in the specific menu item icon, and checks the number of lower menu item icons.

Thereafter, the UI generation unit 140 determines a threshold range that corresponds to the number of checked lower menu item icons, and generates a corresponding menu item icon to have a size or color corresponding to the determined threshold range.

For example, in the case where twenty lower menu item icons 32 are included in a picture menu item icon, it is determined that the lower menu item icons fall within a second threshold range, therefore the picture menu item icon is generated to have an icon size (that is, 8×8) corresponding to the second threshold range.

Furthermore, the UI generation unit 140 may generate icons having the same size but vary the color of each of the menu item icons based on predetermined threshold ranges.

For example, in the case where twenty lower menu item icons 32 are included in the picture menu item icon, it is determined that the lower menu item icons fall within a second threshold range, therefore the picture menu item icon is generated to have an icon color (that is, yellow) corresponding to the second threshold range.

Furthermore, the UI generation unit 140 may generate icons having the same size and color but vary the thickness of connection lines 35 between each menu item icon and the lower menu item icons thereof based on the predetermined threshold ranges.

For example, in the case where twenty lower menu item icons 32 are included in the picture menu item icon, it is determined that the lower menu item icons fall within the second threshold range, therefore the connection lines are generated to have a connection line thickness (that is, 5 mm) corresponding to the second threshold range.

Meanwhile, the UI generation unit 140 may generate the icons (menu item icons, lower menu item icons, and sharer icons) by taking any of icon size and color into account, or may generate the icons by taking both icon size and color into account. Furthermore, the UI may be generated by taking all of icon size, icon color, and connection line thickness into account.

Accordingly, the user can be made aware of the amount of data (or information), which is included in each of the menu item icons, and the relationship with sharers, only by the size and color of each of the menu item icons, the lower menu item icons and the sharer icons, which are provided through the display panel 20.

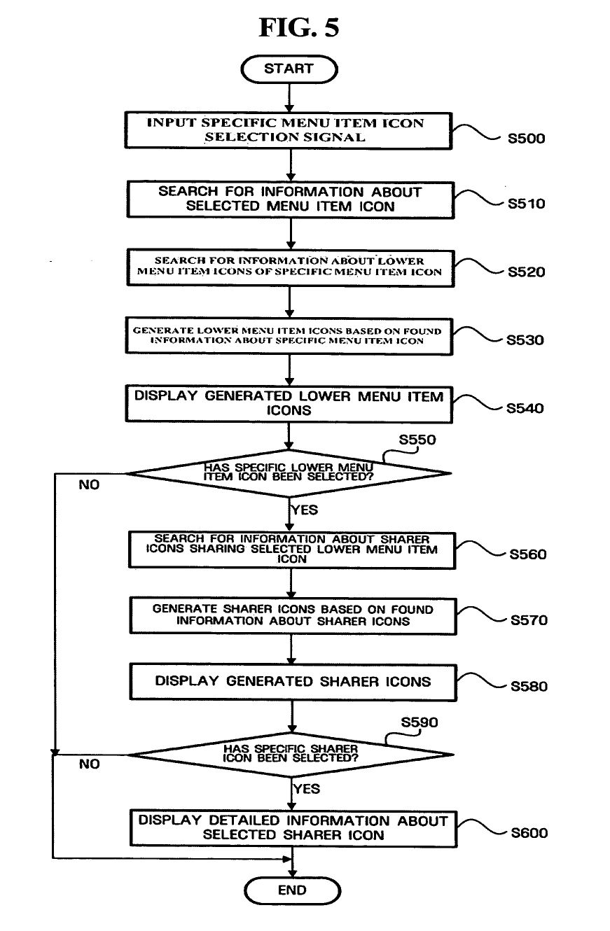

FIG. 5 is a flowchart illustrating a method of providing information about the relationships between respective sharers based on shared information according to an exemplary embodiment of the present invention.

First, when a specific menu item icon is selected by the user, the signal input unit 110 receives a button signal generated by the user's selection of the menu item icon at operation S500.

Thereafter, when the received signal is transmitted to the search unit 120, the search unit 120 searches the second layer region of the storage unit 130 for information about the menu item icon, which is selected by the user, at operation S510, and searches the third layer region of the storage unit 130 for information about the lower menu item icons of the specific menu item icon at operation S520.

Thereafter, the search unit 120 transmits information pertaining to the lower menu item icons to the UI generation unit 140. Accordingly, the UI generation unit 140 generates the lower menu item icons based on the transmitted information about the lower menu item icons at operation S530. In this case, the UI generation unit 140 determines the size and color of each of lower menu item icons based on the number of sharer icons sharing each of lower menu item icons, and generates the lower menu item icons based on the determined size and color.

Thereafter, the lower menu item icons generated by the UI generation unit 140 are displayed on the display panel through the display unit 150 at operation S540.

Thereafter, the signal input unit 110 determines whether a predetermined button signal is generated by the user's selection of a specific lower menu item icon at operation S550. If, as a result of the determination, the predetermined button signal has been generated, the generated signal is input, and is then transmitted to the search unit 120.

Accordingly, the search unit 120 searches the third layer region of the storage unit 130 for information about the lower menu item icon selected by the user, and searches the fourth layer region of the storage unit 130 for information about sharer icons which share a selected lower menu item icon at operation S560.

Thereafter, when the search unit 120 transmits information pertaining to the sharer icons to the UI generation unit 140, the UI generation unit 140 generates the sharer icons based on the transmitted information about the sharer icons at operation S570. In this exemplary embodiment, the UI generation unit 140 determines the size and color of each of the sharer icons based on the relationships between the user of the mobile device 10 and respective sharers (that is, the sharer icons).

Thereafter, the sharer icons generated by the UI generation unit 140 are displayed on the display panel 20 through the display unit 150 at operation S580.

Thereafter, when a specific sharer icon is selected from among the sharer icons, which are displayed by the selection of the user, at operation S590, the signal input unit 110 receives a signal generated at the time of the user's selection of the sharer icon and then transmits the received signal to the search unit 120.

Thereafter, the search unit 120 searches the fourth layer region of the storage unit 130 for the sharer icon selected by the user, and displays detailed information pertaining to the selected sharer icon on the display panel 20 at operation S600.

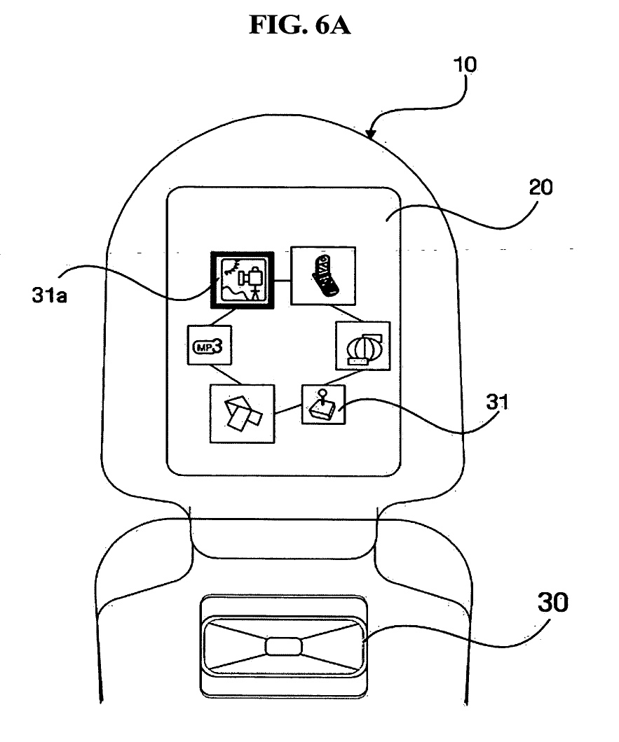

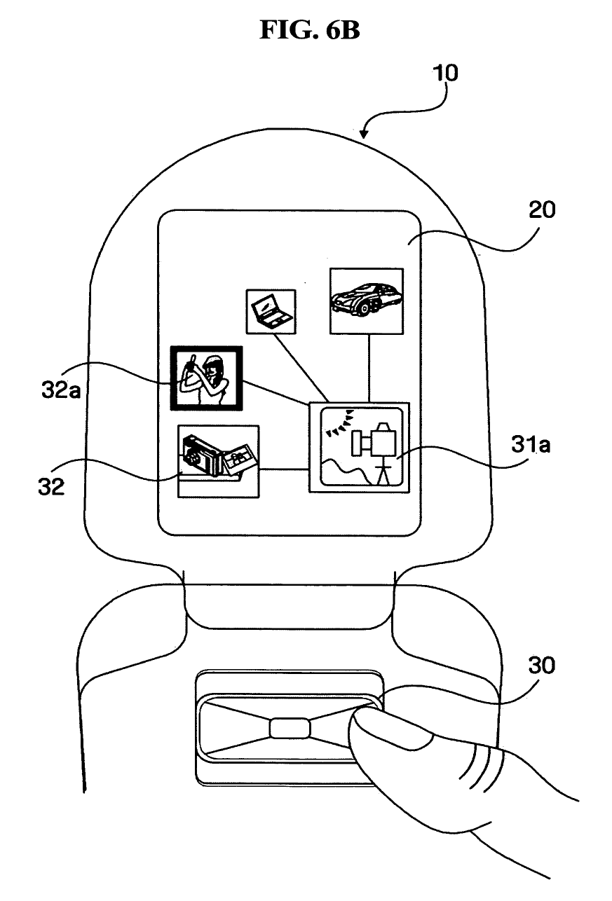

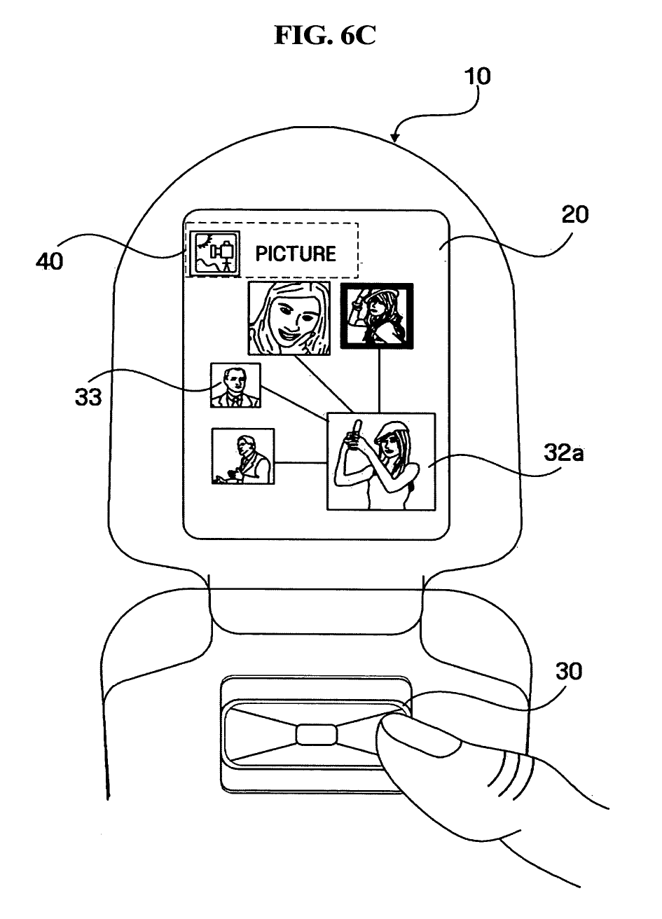

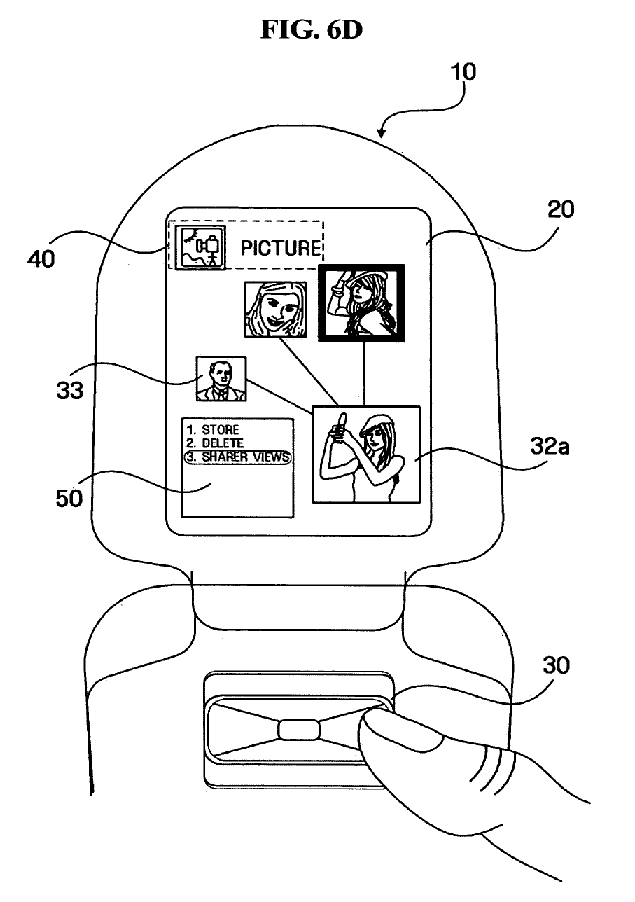

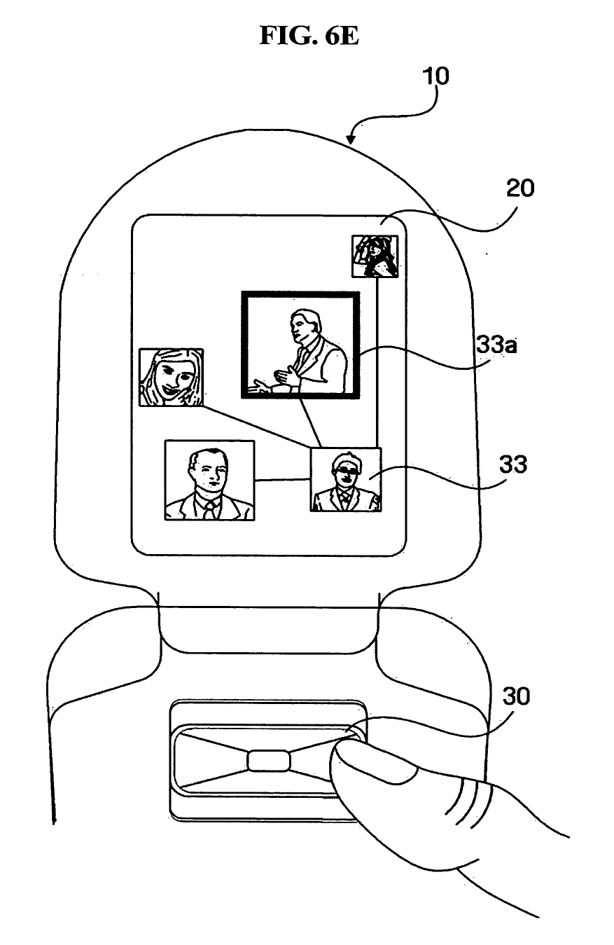

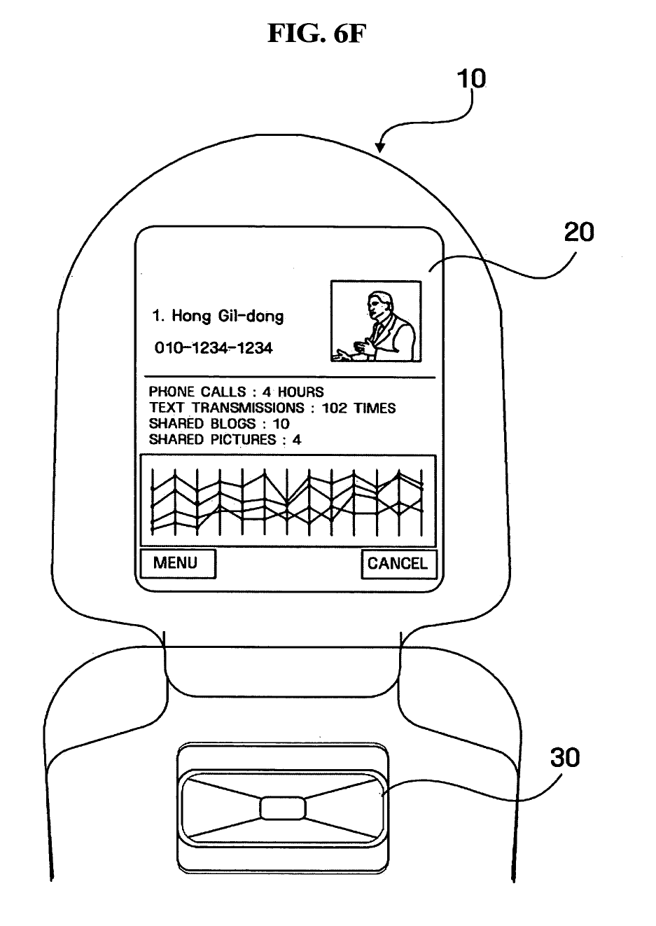

FIGS. 6A to 6F are diagrams showing a process of providing information about the relationships between respective sharers based on shared information according to an exemplary embodiment of the present invention.

As shown in FIG. 6A, a plurality of menu item icons 31 is displayed on the display panel 20 of the mobile device 10. In this case, the menu item icons 31 are generated and displayed as having different sizes based on the number of lower menu item icons.

The current focus is located on a picture menu item icon 31 a. The respective menu item icons can be selected as the user moves the focus by manipulating a predetermined button 30.

Thereafter, when the user selects the picture menu item icon 31a, on which the focus is located, by manipulating the button 30, the lower menu item icons 32 of the picture menu item icon 31a are displayed on the display panel 20 as shown in FIG. 6B.

Thereafter, the user locates the focus on a specific lower menu item icon 32a among the displayed lower menu item icons 32, and selects the corresponding lower menu item icon through the manipulation of the button 30.

Accordingly, as shown in FIG. 6C, sharer icons 33 which share the selected lower menu item icon 32a are displayed on the display panel 20. In this case, the upper menu item icon of the currently activated lower menu item icon (the picture menu item icon 31a) is displayed in a predetermined region 40 of the display panel 20. Accordingly, the user quickly identifies the picture menu item icon 31a in which the currently activated lower menu item icon 32a is included.

Thereafter, when desiring to search for information about sharers who share the activated lower menu item icon 32a, the user activates a menu window 50 using a predetermined button and selects a ‘sharer views’ item in the category of the menu window 50, as shown in FIG. 6D.

Accordingly, as shown in FIG. 6E, the sharer icons 33 sharing the lower menu item icon 32a are displayed on the display panel 20. In this case, a sharer icon, having a high relationship with the user of the mobile device 10, is generated and displayed to have a large size, whereas a sharer icon, having a low relationship with the user of the mobile device 10, is generated and displayed to have a small size.

Thereafter, when desiring to search for detailed information about a specific sharer in the displayed sharer icons, the user moves a focus onto the sharer icon 33a, the detailed information of which will be searched for, through the manipulation of a button, and selects the focused sharer icon 33a.

Accordingly, as shown in FIG. 6F, detailed information (the sharer's name and telephone number, the time for all phone calls, the number of text transmissions, the number of shared blogs, and the number of shared pictures) about a corresponding sharer (for example, Hong Gil-dong) is provided through the display panel 20.

As described above, in accordance with a device and method for providing information about the relationships between respective sharers based on shared information according to the exemplary embodiments of the present invention, one or more effects can be realized as follows:

There is an advantage in that the device and method provide information about the relationships between a user of a mobile device, and sharers who share specific data with the user, through a UI, thus allowing a user to intuitively identify sharers who have relationships with himself or herself.

Furthermore, there is an advantage in that the device and method generate and display the UI (for example, icons) based on the amount of data and the number of sharers stored in the mobile device, thus allowing the user to intuitively receive information through the UI.

Furthermore, there is an advantage in that the UI, which allows the user to be conveniently made aware of data (or files) stored in the mobile device, is provided.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for providing information about relationships between a user of the device and sharers sharing data with the user, the device comprising:
a display panel which displays lower menu item icons of a menu item icon, and sharer icons which indicate relationships between sharers who share the lower menu item icons, if the user selects the menu item icon from among displayed menu item icons; and
a manipulation unit through which manipulation and selection of the displayed menu item icons, the lower menu item icons, and the sharer icons are performed by a user.

2. The device of claim 1, further comprising:
a search unit which searches for information about the lower menu item icons of the selected menu item icon, and the sharer icons which represents sharers who share the lower menu item icons, if the user selects the menu item icon;
a storage unit which stores information about the menu item icon, the lower menu item icons and the sharer icons for respective layer regions;
a User Interface (UI) generation unit which generates the menu item icons, the lower menu item icons, and the sharer icons; and
a display unit which displays the menu item icons, the lower menu item icons, and the sharer icons.

3. The device of claim 2, wherein the UI generation unit determines icon size and color based on a number of lower menu item icons, a number of sharer icons, and a relationships between the user and the sharers.

4. A device for providing relationships between a user of the device and sharers sharing data with the user, the device comprising:
a search unit which searches for information about lower menu item icons of a menu item icon, and sharer icons which represent sharers who share each of the lower menu item icons, if the menu item icon is selected;
a storage unit which stores information about the menu item icon, the lower menu item icons, and the sharer icons for respective layer regions;
a User Interface (UI) generation unit which generates the menu item icons, the lower menu item icons, and the sharer icons; and
a display unit which displays the menu item icons, the lower menu item icon, and the sharer icons.

5. The device of claim 4, wherein the UI generation unit determines icon size and color based on a number of lower menu item icons, a number of sharer icons, and a relationship between the user and the sharers.

6. A method of providing information about relationships between a user of a device and sharers sharing data with the user, the method comprising:
searching for information about lower menu item icons of a menu item icon and displaying the lower menu item icons, if the menu item icon is selected from among displayed menu item icons;
searching for information about a lower menu item icon if the lower menu item icon is selected from among the displayed lower menu item icons; and
searching for information about sharer icons sharing the lower menu item icon which is selected, and displaying the sharer icons.

7. The method of claim 6, wherein a size and color of each of the displayed menu item icons, the lower menu item icons, and the sharer icons are determined based on a number of lower menu item icons, a number of sharer icons, and a relationship between a user and the sharers.

8. The method of claim 6, wherein information about the menu item icons, the lower menu item icons and the sharer icons are stored for respective layer regions.

9. The method of claim 6, further comprising displaying detailed information about a sharer icon if the sharer icon is selected from among the displayed sharer icons.
